(19) United States
(12) Patent Application Publication
(10) Pub. No.: US 2025/0054937 A1
(43) Pub. Date: Feb. 13, 2025

(54) METHOD OF MANUFACTURING ELECTRODE, ELECTRODE, AND BATTERY

(71) Applicant: TOYOTA JIDOSHA KABUSHIKI KAISHA, Toyota-shi (JP)

(72) Inventors: Masashi UEDA, Toyota-shi (JP); Shinji KOJIMA, Nagoya-shi (JP); Tomoko HIGO, Toyota-shi (JP)

(73) Assignee: TOYOTA JIDOSHA KABUSHIKI KAISHA, Toyota-shi (JP)

(21) Appl. No.: 18/660,236

(22) Filed: May 10, 2024

(30) Foreign Application Priority Data
Aug. 9, 2023 (JP) 2023-130509

(51) Int. Cl. H01M 4/04; H01M 4/02; H01M 4/1391

(52) U.S. Cl. CPC H01M 4/0404; H01M 4/1391; H01M 2004/027; H01M 2004/028

(57) ABSTRACT

A method of manufacturing an electrode used in a battery including an electrolytic solution includes a step of coating at least a part of a surface of carbon particles with a resin, a step of mixing the carbon particles coated with the resin and polytetrafluoroethylene to obtain a mixture, and a step of fiberizing the polytetrafluoroethylene in the mixture.

### CROSS-REFERENCE TO RELATED APPLICATION

This application claims priority to Japanese Patent Application No. 2023-130509 filed on Aug. 9, 2023, incorporated herein by reference in its entirety.

### BACKGROUND

### 1. Technical Field

The present disclosure relates to a method of manufacturing an electrode, an electrode, and a battery.

### 2. Description of Related Art

In a battery such as a lithium ion secondary battery, an electrode in which active material particles are fixed to a surface of a current collector such as a metal foil by a binder is used.

As a method of manufacturing an electrode, there is known a method (also referred to as a wet method) in which a composition prepared by mixing active material particles and a binder with a solvent is applied to a surface of a current collector. There is also known a method (also referred to as a dry method) in which active material particles are fixed to a current collector with a binder without using a solvent.

As a method of manufacturing an electrode by a dry method, there is proposed a method in which a resin having a property of fibrillating when a shear force is applied is used as a binder. For example, Japanese Unexamined Patent Application Publication No. 2022-3694 (JP 2022-3694 A) describes the following method of manufacturing an electrode. Polytetrafluoroethylene (PTFE) in a mixture containing active material particles and PTFE is fibrillated to prepare an electrode film. Then, the electrode film is integrated with a current collector to manufacture an electrode.

### SUMMARY

The electrode obtained by the method described in JP 2022-3694 A has room for improvement in cell capacity when applied to a battery (also referred to as a liquid-based battery) in which an electrolytic solution is used.

An object to be addressed by an embodiment of the present disclosure is to provide a method of manufacturing an electrode having an excellent cell capacity when applied to a liquid-based battery, an electrode having an excellent cell capacity when applied to a liquid-based battery, and a battery including the electrode.

The means for addressing the above object includes the following aspects.
<1> A method of manufacturing an electrode to be used in a battery containing an electrolytic solution, including:
coating at least a part of a surface of carbon particles with a resin;
mixing the resin-coated carbon particles with polytetrafluoroethylene to obtain a mixture;
and
fibrillating the polytetrafluoroethylene in the mixture.
<2> The method of manufacturing an electrode according to <1>, in which a coating rate of the carbon particles with the resin is 3% or more.
<3> An electrode to be used in a battery containing an electrolytic solution, including a current collector and an electrode layer, in which the electrode layer contains carbon particles and fibrous polytetrafluoroethylene, at least a part of a surface of the carbon particles being coated with a resin.
<4> The electrode according to <3>, in which a coating rate of the carbon particles with the resin is 3% or more.
<5> A battery including
the electrode according to <3> or <4> and an electrolytic solution.

According to an embodiment of the present disclosure, it is possible to provide a method of manufacturing an electrode having an excellent cell capacity when applied to a liquid-based battery, an electrode having an excellent cell capacity when applied to a liquid-based battery, and a battery including the electrode.

### DETAILED DESCRIPTION OF EMBODIMENTS

In the present disclosure, a numerical range indicated by using “−” means a range including numerical values before and after “−” as a minimum value and a maximum value, respectively.

In the numerical range described in the present disclosure in a stepwise manner, the upper limit value or the lower limit value described in a certain numerical range may be replaced with the upper limit value or the lower limit value of the numerical range described in another stepwise manner. In the numerical ranges described in the present disclosure, the upper limit value or the lower limit value described in a certain numerical range may be replaced with the value shown in the examples.

In the present disclosure, the term “step” is included in the term as long as the intended purpose of the step is achieved, even if it is not clearly distinguishable from other steps as well as independent steps.

In the present disclosure, a combination of two or more preferred embodiments is a more preferred embodiment.

In the present disclosure, the amount of each component means the total amount of a plurality of substances unless otherwise specified, when a plurality of substances corresponding to each component are present.

### Method of Manufacturing Electrode

A method of manufacturing an electrode of the present disclosure is a method of manufacturing an electrode used in a battery including an electrolytic solution. The method includes a step of coating at least a portion of a surface of the carbon particles with a resin, a step of mixing the carbon particles coated with the resin and polytetrafluoroethylene to obtain a mixture, and a step of fiberizing the polytetrafluoroethylene in the mixture.

Electrodes produced by the disclosed methods exhibit superior cell capacities when applied to liquid-based batteries compared to electrodes formed from mixtures obtained by mixing non-resin-coated carbon-particles with PTFE. The reason for this is considered as follows, for example.

An electrode made by fiberizing a PTFE contained as a binder together with carbon particles has a smaller contact area between the carbon particles and the binder than an electrode obtained by another method (a wet method, an electrostatic method, or the like), and has a larger area where the surface of the carbon particles is exposed.

Therefore, the amount of the coating film called Solid Electrolyte Interface (SEI) formed on the surface of the carbon-particle during the first charge/discharge of the battery is relatively large.

SEI has a function of suppressing decomposition of the electrolytic solution. However, excessive SEI formation leads to an increase in irreversible capacity (i.e., a decrease in cell capacity) due to lithium-ion immobilization.

In the method of the present disclosure, an electrode is manufactured using carbon particles in which at least a part of a surface of the carbon particles is coated with a resin. As a result, excessive SEI formation is suppressed, and a sufficient cell volume is maintained.

According to the method of the present disclosure, an electrode can be manufactured without using a solvent. Therefore, the method of the present disclosure is also advantageous in terms of reducing the manufacturing cost of the electrode, reducing the influence on the environment and the living body, and the like.

Hereinafter, the step of coating at least a part of the surface of the carbon particles with a resin is also referred to as “step 1”. The step of mixing the resin-coated carbon-particles and PTFE to obtain a mixture is also referred to as “step 2”. The step of fiberizing PTFE in the blend is also referred to as “step 3”.

### Process 1

In step 1, at least a portion of the surface of the carbon particles is coated with a resin.

The type of the carbon particles used in this step is not particularly limited, and may be selected from materials commonly used as negative electrode active materials.

Specific examples of the material of the carbon particles include graphite, soft carbon, and hard carbon. The carbon particles may be secondary particles formed by aggregation of a plurality of primary particles.

The carbon particles used in the production of the electrode may be one kind alone or two or more kinds thereof.

The volume average particle diameter of the carbon particles is not particularly limited, and may be selected from the range of 5 μm to 30 μm, for example.

The volume-average particle size of the particles is a D50 when the cumulative particle size from the smaller diameter side is 50% in the volume-based particle size distribution measured by the laser diffractometry and scattering method.

The type of the resin used for coating the carbon particles in this step is not particularly limited, and may be selected from materials commonly used in the manufacture of batteries.

Specific examples of the resin include polyvinylidene fluoride, polyethylene, polypropylene, polyethylene terephthalate, cellulose, nitrocellulose, carboxymethylcellulose, polyethylene oxide, polyepichlorohydrin, polyacrylonitrile, styrene-butadiene rubber (SBR), acrylonitrile-butadiene rubber (NBR), polyacrylate, and polymethacrylate. The resin used in this step may be one kind alone or two or more kinds thereof. From the viewpoint of adhesive strength, compatibility with PTFE, electrolytic solution resistance, and the like, polyvinylidene fluoride (PVdF) is preferable as the resin.

From the viewpoint of ensuring sufficient cell capacity, the coverage of the surface of the carbon particles by the resin is preferably 3% or more, more preferably 5% or more, and still more preferably 10% or more. The coverage of the surface of the carbon particles by the resin may be 60% or less, 50% or less, or 40% or less.

The coverage of the surface of the carbon particles by the resin is measured by an image analysis method.

Examples of the image-analysis method include a method in which F-mapping is performed by energy-dispersive X-ray spectroscopy (EDX). Specifically, the resin-coated carbon-particles are observed by scanning electron microscopy (SEM) and F-mapped by EDX. The region X corresponding to the carbon particles and the region Y of the region X in which the resin (F) is present are binarized, and the coverage ratio is calculated by the following formula.

Coverage (%)=(area of Y/area of X)×100.

In this step, the method of coating at least a part of the surface of the carbon particles with the resin is not particularly limited, and can be carried out by a known method. For example, a composite treatment may be performed in which the carbon particles and the resin are kneaded with a mixer or the like and at least a part of the surface of the carbon particles is coated with the resin.

The amount of the resin with respect to 100 parts by mass of the carbon particles can be selected, for example, from the range of 1 part by mass to 20 parts by mass, or 2 parts by mass to 10 parts by mass.

### Step 2

In step 2, the resin-coated carbon-particles and PTFE are mixed to obtain a blend. The method of mixing is not particularly limited, and can be carried out using known means.

The amount of PTFE with respect to 100 parts by mass of the carbon particles in the mixture can be selected, for example, from the range of 0.1 parts by mass—10 parts by mass, or 1 part by mass—5 parts by mass.

PTFE mixed with the carbon-particles in step 2 may be in particulate form. The mixture obtained in step 2 may be solvent-free.

In step 2, at least a portion of PTFE may be fiberized, and a granulated material in which the carbon-particles are bound by the fiberized PTFE may be produced.

Mixtures of resin-coated carbon-particles and PTFE may include binders other than PTFE. The binder other than PTFE may be selected from, for example, the above-described resins for coating the carbon-particles.

When the blend contains a binder other than PTFE, the content thereof may be 20 parts by mass or less, 10 parts by mass or less, or 5% by mass or less based on parts by mass of PTFE100.

Mixtures of resin-coated carbon-particles and PTFE may include a conductive material. Specific examples of the conductive material include carbon materials such as carbon black (acetylene black, thermal black, furnace black, and the like) and carbon nanotubes.

When the mixture contains a conductive material, the content thereof can be selected from the range of 0.1 parts by mass-10 parts by mass, or 1 part by mass-5 parts by mass, with respect to 100 parts by mass of the carbon particles.

### Step 3

In step 3, PTFE in the blend obtained in step 2 is fiberized.

The process for fiberizing PTFE is not particularly limited, and can be carried out using a known process.

From the viewpoint of workability when integrating the mixture after fiberizing PEFE with the current collector, in step 3, it is preferable to fibrillate PTFE and form the mixture into a sheet-like shape.

Examples of methods for forming PTFE into fibers and forming the blend into a sheet-like shape include a rolling process using a roll press machine.

The thickness of the molded body obtained by forming the mixture into a sheet is not particularly limited, and can be adjusted according to the desired thickness of the electrode layer. For example, the thickness of the molded body can be selected from the range of 10 μm to 200 μm.

After fiberizing PTFE in step 3, the mixture, preferably a sheet-like shaped body, is integrated with the current collector to form an electrode.

The method of integrating the mixed material after fiberizing PTFE with the current collector is not particularly limited, and can be carried out using a known method. For example, the mixture and the current collector may be pressure-bonded using a roll press, a flat plate press, or the like.

The material of the current collector is not particularly limited, and may be selected from known materials such as aluminum, copper, nickel, titanium, and stainless steel.

### Electrode

The electrode of the present disclosure is an electrode used in a battery including an electrolytic solution. The electrode includes a current collector and an electrode layer. The electrode layer includes carbon-particles at least partially-coated with a resin- and a fibrous polytetrafluoroethylene (PTFE fiber).

The electrode of the present disclosure exhibits superior cell capacitance as compared to an electrode comprising non-resin-coated carbon-particles and PTFE fibers.

The details and preferred aspects of each material included in the electrodes and electrodes of the present disclosure are the same as the details and preferred aspects of the electrodes and each material used in the above-described method of manufacturing an electrode.

The electrode may further include a member other than the electrode layers including the current collector, the active material grains, and PTFE fibers. For example, the disclosed electrodes may further include electrode layers that do not include PTFE fibers.

### Battery

The battery of the present disclosure includes the electrode of the present disclosure described above and an electrolytic solution.

The battery of the present disclosure includes the electrode of the present disclosure as a negative electrode.

The type of the electrolytic solution contained in the battery is not particularly limited, and may be selected from electrolytic solutions commonly used in liquid-based batteries.

The type of battery of this disclosure is not specifically restricted and can be selected from: lithium ion secondary battery, lead battery, nickel-hydrogen battery, nickel-cadmium battery, nickel-iron battery, nickel-zinc battery, silver-zinc oxide battery, cobalt titanium secondary battery, sodium ion secondary battery, etc.

Hereinafter, the present disclosure will be described in more detail with reference to Examples, but the disclosure of the present disclosure is not limited to these Examples.

### Example: Preparation of Anode

MP mixer (Nippon Coke Industries Co., Ltd.) was charged with the following ingredients in the amounts shown in Table 1 and subjected to a compounding treatment in which the surface of the carbon particles was coated with a resin at a 10000 rpm of 10 minutes.
Carbon particles: graphite (volume average particle diameter: 20 μm)
Plastics: PVdF

PTFE was further charged into MP mixer after the compounding treatment and mixed at a 300 rpm of 180 seconds. Then, the mixture was further mixed at a 5000 rpm of 500 seconds so as to form a granulate in which the carbon-particles were bound by the fiberized PTFE.

The mixture containing the granulate is rolled in a roll press (linear rolling: 0.4t/cm), PTFE was fiberized and formed into a sheet-like shape (thickness: 200 μm). A sheet-shaped molded article and a copper foil (thickness: 8 μm) as a current collector were bonded to each other by a flat plate press (load: 5t, 160° C.).

Through the above-described steps, a negative electrode was obtained in which a negative electrode layer including carbon particles and PTFE fibers having at least a part of the surface covered with a resin was disposed on a current collector.

### Comparative Example: Preparation of Negative Electrode

A negative electrode was prepared in the same manner as in Example 1, except that a composite treatment of carbon particles was not performed.

### Evaluation of Coverage

The carbon particles after the compounding treatment were observed by SEM, and F-mapping was performed by a EDX attached to SEM to calculate the resin-coated ratio of the carbon particles. The results are shown in Table 1.

### Evaluation of Cell Capacity

A small cell was manufactured using the negative electrode manufactured in Examples and Comparative Examples and the positive electrode manufactured by the following method. As the electrolytic solution, 1. Mixed solvents (EC:DMC:EMC=30:34:36, vol %) of ethylene carbonate, dimethyl carbonate and ethyl methyl carbonate containing LiPF₆ of 14M were used.

The discharge capacity was measured by the following method using the fabricated small cell. The results are shown in Table 1. Measurement method: at a current value of 0.3 C, perform CCCV (cut-off current: 1/20 C) within 4.25 V-2.5 V to calculate the discharging capacitance (mAh/g).

### Preparation of Positive Electrode

A paste containing NCM (97.5 parts by mass) as positive electrode active material, acetylene black (1.5 parts by mass) as a conductive material, and PVdF (1 part by mass) as a binder was coated on an aluminum foil (thickness: 12 μm) as a current collector to prepare a positive electrode.

TABLE 1

| | Composition (% by weight) | | | | |
|---|---|---|---|---|---|
| | Carbon | | | Coverage | Capacity |
| | particle | PVdF | PTFE | (%) | (mAh/g) |
| Comparative | 97.0 | 0.0 | 3.0 | 0.0 | 122 |
| Example | | | | | |
| Example 1 | 94.5 | 2.5 | 3.0 | 4.0 | 146 |
| Example 2 | 92.0 | 5.0 | 3.0 | 10.1 | 170 |
| Example 3 | 89.5 | 7.5 | 3.0 | 20.0 | 175 |
| Example 4 | 87.0 | 10.0 | 3.0 | 28.0 | 176 |

As shown in Table 1, the positive electrode of the example in which at least a part of the surface was made of carbon particles and PTFE coated with resin has a larger cell volume than the positive electrode of the comparative example in which the surface was made of carbon particles and PTFE not coated with resin.

These findings suggest that coating the surface of the carbon particles with a resin suppresses excessive SEI formation on the surface of the carbon particles and contributes to an increase in cell capacitance.

What is claimed is:

1. A method of manufacturing an electrode to be used in a battery containing an electrolytic solution, comprising:
coating at least a part of a surface of carbon particles with a resin;
mixing the resin-coated carbon particles with polytetrafluoroethylene to obtain a mixture; and
fibrillating the polytetrafluoroethylene in the mixture.

2. The method according to claim 1, wherein a coating rate of the carbon particles with the resin is 3% or more.

3. An electrode to be used in a battery containing an electrolytic solution, comprising a current collector and an electrode layer, wherein the electrode layer contains carbon particles and fibrous polytetrafluoroethylene, and at least a part of a surface of the carbon particles is coated with a resin.

4. The electrode according to claim 3, wherein a coating rate of the carbon particles with the resin is 3% or more.

5. A battery comprising the electrode according to claim 3 and an electrolytic solution.
